(19) United States
(12) Patent Application Publication
(10) Pub. No.: US 2022/0317083 A1
(43) Pub. Date: Oct. 6, 2022

(54) GAS SENSOR

(71) Applicant: NGK Insulators, Ltd., Nagoya-shi (JP)

(72) Inventors: Yusuke WATANABE, Nagoya-shi (JP); Shotaro NIIZUMA, Nagoya-shi (JP); Hayami AOTA, Nagoya-shi (JP); Toshihiro HIRAKAWA, Nagoya-shi (JP)

(21) Appl. No.: 17/699,896

(22) Filed: Mar. 21, 2022

(30) Foreign Application Priority Data
Mar. 31, 2021 (JP) 2021-059268

(51) Int. Cl. G01N 27/407; G01N 27/406

(52) U.S. Cl. CPC G01N 27/4071; G01N 27/4067; G01N 27/4077

(57) ABSTRACT

Provided is a gas sensor intended to achieve improved measurement accuracy. A gas sensor according to one aspect of the present invention includes: a gas sensor element including a gas introduction opening and a gas exhaust unit; and a protective member including a plurality of porous layers and configured to cover the gas sensor element. The plurality of porous layers include a first porous layer arranged on the innermost side and a second porous layer arranged on an outer side of the first porous layer. The first porous layer has a higher porosity than the second porous layer. The gas introduction opening and the gas exhaust unit are covered by the first porous layer. The protective member includes, between the gas introduction opening and the gas exhaust unit, a restricting portion configured to restrict the flow of gas.

### CROSS-REFERENCE TO RELATED APPLICATION

The present application claims priority from Japanese application JP2021-059268, filed on Mar. 31, 2021, the contents of which is hereby incorporated by reference into this application.

### TECHNICAL FIELD

The present invention relates to a gas sensor.

### BACKGROUND ART

The development of solid electrolyte-based gas sensors has been moving forward heretofore (see JP 2018-040746A, for example). In one example, such a gas sensor is placed in an exhaust gas pipe of a vehicle for the purpose of monitoring exhaust gas from the vehicle. If the gas sensor is wetted with water, the efficiency of activating the solid electrolyte by a heater is reduced. As a result, the time required to start up the gas sensor (start-up time) is extended. The extended start-up time of the gas sensor causes a problem in that, e.g., gas monitoring cannot be started upon the start of the engine of the vehicle. To address this problem, various attempts have been made to keep a gas sensor element from getting wet with water (to improve the water intrusion resistance of the gas sensor element).

JP 2015-059758A has proposed covering a gas sensor element with a plurality of protective layers (porous layers). The protective layers proposed in JP 2015-059758A are adapted such that a first protective layer arranged on the inner side (i.e., in contact with the element) has a higher porosity than a second protective layer arranged on the outer side. The protective layers thus configured can effectively prevent water from entering the protective layers while securing the passage of gas to a gas introduction opening, and can keep water from coming into direct contact with the gas sensor element. As a result, the water intrusion resistance of the gas sensor element can be improved, whereby the start-up time of the gas sensor element can be shortened.

JP 2018-040746A is an example of related art. JP 2015-059758A is another example of related art.

### SUMMARY OF THE INVENTION

The inventors of the present invention found that the conventional protective layers have the following problem. Recent years have seen demand for further improvement in the measurement accuracy of gas sensors. However, a gas sensor element is typically provided with a gas exhaust unit such as an electrode for discharging gas that has been pumped out, for example. This gas exhaust unit may be arranged near a gas introduction opening. In this case, since the first protective layer has a high porosity, gas discharged from the gas exhaust unit may flow into the gas introduction opening through the first protective layer to mix with gas to be measured. This may adversely affect the measurement accuracy of a gas sensor (this may deteriorate the measurement accuracy and complicate the calibration, for example).

One aspect of the present invention was made in light of the foregoing, and it is an object thereof to provide a gas sensor intended to achieve improved measurement accuracy.

In order to solve the above-described problem, the present invention adopts the following configuration.

A gas sensor according to one aspect of the present invention includes: a gas sensor element including a gas introduction opening and a gas exhaust unit; and a protective member including a plurality of porous layers and configured to cover the gas sensor element. The plurality of porous layers include a first porous layer arranged on an innermost side and a second porous layer arranged on an outer side of the first porous layer. The first porous layer has a higher porosity than the second porous layer. The gas introduction opening and the gas exhaust unit of the gas sensor element are covered by the protective member in such a manner that the gas introduction opening and the gas exhaust unit are in contact with the first porous layer. The protective member includes, between the gas introduction opening and the gas exhaust unit, a restricting portion configured such that a thickness of the first porous layer present therein is reduced as compared with thicknesses of portions covering the gas introduction opening and the gas exhaust unit to such an extent that flow of gas is inhibited, whereby the second porous layer restricts the flow of gas between the gas introduction opening and the gas exhaust unit.

In this configuration, the gas introduction opening and the gas exhaust unit of the gas sensor element are covered in such a manner that they are in contact with the first porous layer of the protective member. In addition, between the gas introduction opening and the gas exhaust unit, the restricting portion configured to inhibit the flow of gas is provided. This restricting portion can keep gas discharged from the gas exhaust unit from entering the gas introduction opening. As a result, gas discharged from the gas exhaust unit can be kept from mixing with gas to be measured, thereby enabling improvement of the measurement accuracy of the gas sensor. In one example, the reduction of the thickness of the first porous layer to such an extent that the flow of gas is inhibited may be achieved by the configuration in which the first porous layer is not present in the restricting portion or the configuration in which an average thickness of the first porous layer in the restricting portion is less than 30% of a maximum thickness of the first porous layer in portions where the first porous layer covers the gas introduction opening and the gas exhaust unit. The state where the flow of gas is inhibited is preferably the state where the flow of gas is blocked.

In the gas sensor according to the above aspect, a cross-sectional shape of the first porous layer in each of a portion where the first porous layer covers the gas introduction opening and a portion where the first porous layer covers the gas exhaust unit may be in an arch shape. The arch shape may be a shape that is thickest in the middle and gradually becomes thinner toward both ends. According to this configuration, since the cross-sectional shape of the first porous layer in each of the portion where the first porous layer covers the gas introduction opening and the portion where the first porous layer covers the gas exhaust unit is in an arch shape, the restricting portion can be effectively provided between the gas introduction opening and the gas exhaust unit. As a result, the flow of gas between them can be blocked effectively. This enables the improvement of the measurement accuracy of the gas sensor. In addition, by adopting an arch shape, the strength of the protective member can be enhanced.

In the gas sensor according to the above aspect, the restricting portion may be configured such that the first porous layer is not present therein, whereby the second porous layer restricts the flow of gas between the gas introduction opening and the gas exhaust unit. The absence of the first porous layer corresponds to a state where, of gas passages assumed to be present between the gas introduction opening and the gas exhaust unit in the protective member, the first porous layer is disconnected in at least part of each assumed passage. According to this configuration, the restricting portion can be effectively provided between the gas introduction opening and the gas exhaust unit, whereby the flow of gas between them can be effectively blocked. This enables the improvement of the measurement accuracy of the gas sensor.

In the gas sensor according to the above aspect, the restricting portion may be configured such that, in the restriction portion, an average thickness of the first porous layer is less than 30% of a maximum thickness of the first porous layer in portions where the first porous layer covers the gas introduction opening and the gas exhaust unit, whereby the second porous layer restricts the flow of gas between the gas introduction opening and the gas exhaust unit. According to this configuration, since the thickness of the first porous layer is reduced so as to satisfy the above indication, the restricting portion can be effectively provided between the gas introduction opening and the gas exhaust unit, whereby the flow of gas between them can be blocked effectively. This enables the improvement of the measurement accuracy of the gas sensor.

In the gas sensor according to the above aspect, a portion of the protective member covering the gas introduction opening is constituted by two porous layers consisting of the first porous layer and the second porous layer. In the protective member, if the number of porous layers stacked in the portion of the protective member covering the gas introduction opening is increased, it becomes more and more difficult for gas to flow into the gas introduction opening, whereby the responsiveness of the gas sensor may be deteriorated. According to the above configuration, since the number of porous layers in the portion of the protective member covering the gas introduction opening is limited to two, it is possible to ensure the responsiveness of the gas sensor while enhancing the water intrusion resistance of the gas introduction opening.

In the gas sensor according to the above aspect, the gas sensor element may include a first face and a second surface that is in contact with the first face, the gas introduction opening may be on the first face, and the gas exhaust unit may be arranged on the second face. A corner between the first face and the second face may be chamfered, and the restricting portion may be provided in the chamfered corner. According to this configuration, since the gas introduction opening and the gas exhaust unit are on different faces and the restricting portion is provided in the chamfered portion between the first face and the second face, the flow of gas between the gas introduction opening and the gas exhaust unit can be effectively blocked. This enables the improvement of the measurement accuracy of the gas sensor.

In the gas sensor according to the above aspect, the gas sensor element may further include a third face, and the gas sensor element may further include a heater arranged on a side closer to the third face. The thickness of the first porous layer in a portion where the first porous layer covers the third face may be smaller than the thickness of the first porous layer in a portion where the first porous layer covers the gas exhaust unit. According to this configuration, since the protective member covers not only the first face and the second face but also at least part of the face located near the heater (the third face), the strength of the gas sensor can be enhanced. Furthermore, when the gas sensor includes the heater, a portion of the protective member close to the gas exhaust unit is more likely to crack than a portion of the protective member close to the heater. To address this problem, according to this configuration, the thickness of the first porous layer in the portion close to the gas exhaust unit (i.e., on the second face) is set larger than the thickness of the first porous layer in the portion close to the heater (i.e., on the third face). This can reduce the possibility that cracking may occur.

In the gas sensor according to the above aspect, the gas sensor element may include a portion not covered by the protective member. The gas sensor element may further include a gas detection unit arranged in the portion not covered by the protective member. According to this configuration, since the gas detection unit is arranged in the portion not covered by the protective member, gas discharged from the gas exhaust unit covered by the protective member can be effectively kept from flowing toward the gas detection unit. As a result, it is possible to reduce the influence of the gas discharged from the gas exhaust unit, thereby enabling the improvement of the measurement accuracy of the gas detection unit.

In the gas sensor according to the above aspect, the gas sensor element may include a plurality of solid electrolyte layers being stacked together. Of the plurality of solid electrolyte layers, a face of the solid electrolyte layer arranged on at least one of outermost sides in a stacking direction may be at least partially covered by an insulating layer. In a portion covered by the insulating layer, the gas sensor element may be covered by the protective member with the insulating layer interposed between the gas sensor element and the protective member. The insulating layer can be made of the same material as the porous layers of the protective member. Accordingly, when the gas sensor element constituted by the plurality of solid electrolyte layers is covered by the porous layers of the protective member with the insulating layer interposed therebetween, the adhesion between the gas sensor element and the protective member can be enhanced as compared with the case where the gas sensor element is directly covered by the porous layers. Accordingly, it is possible to provide a gas sensor in which detachment of the protective member is less likely to occur.

According to the present invention, it is possible to provide a gas sensor intended to achieve improved measurement accuracy.

### BRIEF DESCRIPTION OF THE DRAWINGS

FIG. 1 is a schematic view showing, in order to schematically illustrate an example configuration of a gas sensor according to an embodiment, a cross-section of the gas sensor perpendicular to the longitudinal direction.

FIG. 2 is a schematic view showing, in order to schematically illustrate the example configuration of the gas sensor according to the embodiment, a cross-section of the gas sensor parallel to the longitudinal direction.

FIG. 3 is a schematic cross-sectional view schematically illustrating an example configuration of a gas sensor element according to the embodiment.

FIG. 4 is a schematic view showing, in order to schematically illustrate an example configuration of a gas sensor according to a modified example, a cross-section of the gas sensor perpendicular to the longitudinal direction.

FIG. 5 is a schematic view showing, in order to schematically illustrate the example configuration of the gas sensor according to the above modified example, a cross-section of the gas sensor parallel to the longitudinal direction.

FIG. 6 is a schematic cross-sectional view schematically illustrating an example configuration of a gas sensor element according to the above modified example.

FIG. 7 is a schematic view showing, in order to schematically illustrate an example configuration of a gas sensor according to another modified example, a cross-section of the gas sensor parallel to the longitudinal direction.

FIG. 8 is a schematic cross-sectional view schematically illustrating an example configuration of a gas sensor element according to the above modified example.

FIG. 9 is a schematic view showing, in order to schematically illustrate an example configuration of a gas sensor according to still another modified example, a cross-section of the gas sensor perpendicular to the longitudinal direction.

FIG. 10 is a schematic view showing, in order to schematically illustrate the example configuration of a gas sensor according to the above modified example, a cross-section of the gas sensor parallel to the longitudinal direction.

FIG. 11 is a graph illustrating the linear ratio of Ip0.

### EMBODIMENTS OF THE INVENTION

Hereinafter, an embodiment according to one aspect of the present invention (hereinafter also referred to as “the present embodiment”) will be described with reference to the drawings. It is to be noted, however, that the present embodiment to be described below is in all respects merely illustrative of the present invention. It goes without saying that various improvements and modifications can be made without departing from the scope of the present invention. In other words, in the practice of the present invention, specific configurations suitable for embodiments may be employed as appropriate.

### Configuration Examples

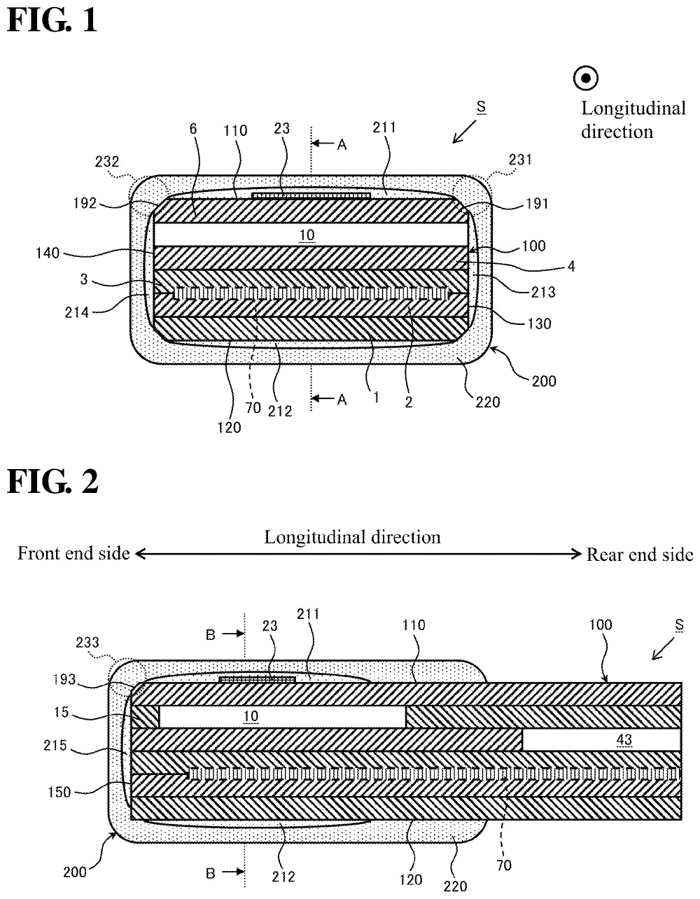

FIG. 1 is a schematic view showing, in order to schematically illustrate an example configuration of a gas sensor S according to the present embodiment, a cross-section of the gas sensor S perpendicular to the longitudinal direction. FIG. 2 is a schematic view showing, in order to schematically illustrate the example configuration of the gas sensor S according to the present embodiment, a cross-section of the gas sensor S parallel to the longitudinal direction. FIG. 1 schematically shows the cross-section taken along B-B in FIG. 2, and FIG. 2 schematically shows the cross-section taken along A-A in FIG. 1.

In the present embodiment, the gas sensor S has an axis and is configured to extend along the longitudinal direction (axial direction). The longitudinal direction is a direction perpendicular to the plane of FIG. 1 and a left-right direction in FIG. 2. The gas sensor S has a front end and a rear end as respective ends in the longitudinal direction. The front end is one end in the longitudinal direction (the left end in FIG. 2), and the rear end is the other end in the longitudinal direction (the right end in FIG. 2). The gas sensor S according to the present embodiment includes a gas sensor element 100 and a protective member 200.

Gas Sensor Element

The gas sensor element 100 according to the present embodiment is configured to extend along the longitudinal direction. In the example shown in FIGS. 1 and 2, the gas sensor element 100 is formed in a cuboid shape. However, the shape of the gas sensor element 100 need not be limited to such an example, and may be selected as appropriate according to the specifics of implementation.

In the present embodiment, the gas sensor element 100 has a front end portion and a rear end portion as respective end portions in the longitudinal direction. The gas sensor element 100 is arranged such that the front end portion thereof faces toward the front end of the gas sensor S. The gas sensor element 100 has a front face 150 as a face of the front end portion. The gas sensor element 100 has an upper face 110 and a lower face 120 as respective end faces in the vertical direction (i.e., in the upper-lower direction in FIGS. 1 and 2) perpendicular to the longitudinal direction. The gas sensor element 100 also has a first side face 130 (the face on the right in FIG. 1) and a second side face 140 (the face on the left in FIG. 1) as respective end faces in the horizontal direction perpendicular to the longitudinal direction (i.e., the left-right direction in FIG. 1 and a direction perpendicular to the plane of FIG. 2).

As shown in FIGS. 1 and 2, the upper face 110 is in contact with the first side face 130, the second side face 140, and the front face 150. Also, the lower face 120 is in contact with the first side face 130, the second side face 140, and the front face 150. A corner 191 between the upper face 110 and the first side face 130, a corner 192 between the upper face 110 and the second side face 140, a corner 193 between the upper face 110 and the front face 150, a corner between the lower face 120 and the first side face, and a corner between the lower face 120 and the second side face are each chamfered. The corners (191, 192, 193) of the upper face 110 may be chamfered either continuously or discontinuously. The chamfering of at least one corner selected from the corners 191 to 193, the corner between the lower face 120 and the first side face, and the corner between the lower face 120 and the second side face may be omitted. Although the corner between the lower face 120 and the front face 150 is not chamfered in the example shown in FIG. 2, this corner may also be chamfered. Likewise, the respective corners on the rear face side of the gas sensor element 100 also may be chamfered.

The gas sensor element 100 includes a gas introduction opening 10 and a gas exhaust unit (an external pump electrode 23 to be described below). As long as the gas sensor element 100 includes the gas introduction opening and the gas exhaust unit and is configured to measure the concentration of any desired gas component, the configuration of the gas sensor element 100 need not be limited to any particular one and can be determined as appropriate according to the specifics of implementation. An example configuration of the gas sensor element 100 will be described below.

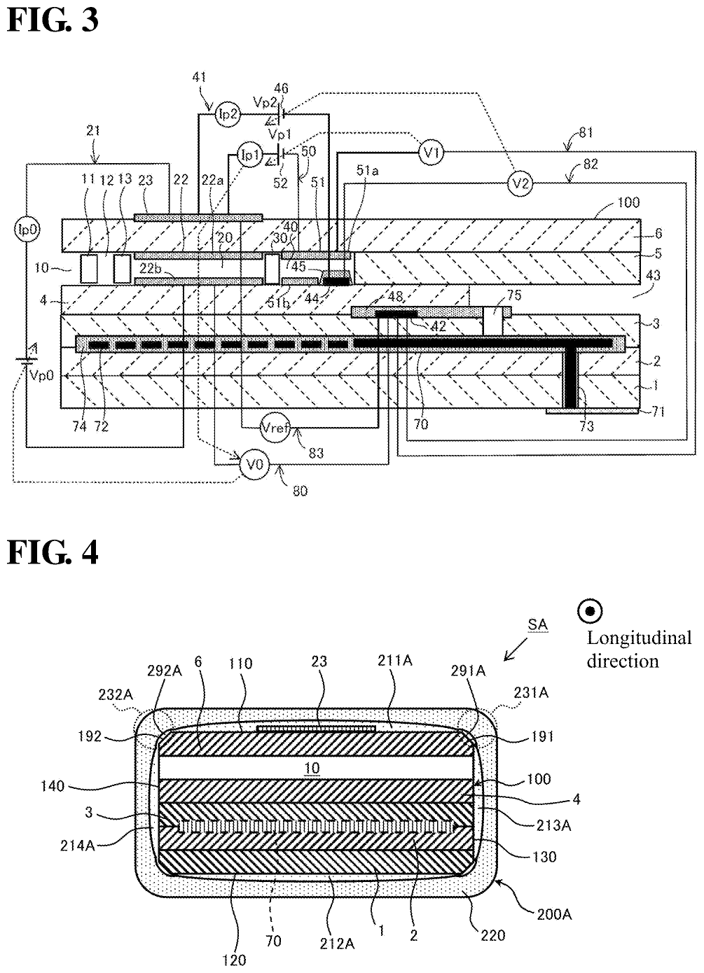

FIG. 3 is a schematic cross-sectional view schematically showing an example configuration of the gas sensor element 100 according to the present embodiment. The respective directions in FIG. 3 are the same as those in FIG. 2. The gas sensor element 100 has a structure in which six layers, namely, a first substrate layer 1, a second substrate layer 2, a third substrate layer 3, a first solid electrolyte layer 4, a spacer layer 5, and a second solid electrolyte layer 6 are stacked in this order from the lower side in the cross-section of FIG. 3, and these layers are each constituted by an oxygen ion-conductive solid electrolyte layer made of zirconia (ZrO₂) or the like. The solid electrolyte forming these six layers may be a dense material. The term “dense” as used herein refers to having a porosity of 5% or less.

The gas sensor element 100 is produced, for example, by performing steps such as predetermined processing and printing of wiring patterns on ceramic green sheets corresponding to the respective layers, stacking the resultant layers, and integrating them through firing. In one example, the gas sensor element 100 is a stack of a plurality of ceramic layers. In the present embodiment, an upper face of the second solid electrolyte layer 6 forms the upper face 110 of the gas sensor element 100, a lower face of the first substrate layer 1 forms the lower surface 120 of the gas sensor element 100, and side faces of the layers 1 to 6 form the side faces (130, 140) of the gas sensor element 100.

In the front end portion of the gas sensor element 100, the gas introduction opening 10, a first diffusion control unit 11, a buffer space 12, a second diffusion control unit 13, a first internal cavity 20, a third diffusion control unit 30, and a second internal cavity 40 are arranged adjacent to each other in this order in a connected manner between the lower face of the second solid electrolyte layer 6 and the upper face of the first solid electrolyte layer 4.

The gas introduction opening 10, the buffer space 12, the first internal cavity 20, and the second internal cavity 40 are spaces inside the gas sensor element 100. These spaces are each formed by cutting out the spacer layer 5, and each have an upper portion defined by the lower face of the second solid electrolyte layer 6, a lower portion defined by the upper face of the first solid electrolyte layer 4, and side portions defined by the side faces of the spacer layer 5.

The first diffusion control unit 11 is provided as two laterally long slits (whose openings have the long-side direction along a direction perpendicular to the plane of FIG. 3). The second diffusion control unit 13 and the third diffusion control unit 30 are provided as holes whose lengths extending in a direction perpendicular to the plane of FIG. 3 are shorter than the first internal cavity 20 and the second internal cavity 40, respectively. The second diffusion control unit 13 and the third diffusion control unit 30 will be described in detail below. Note that the region from the gas introduction opening 10 to the second internal cavity 40 is also referred to as a gas flow passage.

A reference gas introduction space 43 having side portions defined by the side faces of the first solid electrolyte layer 4 is provided between the upper face of the third substrate layer 3 and the lower face of the spacer layer 5, at a position that is farther from the front end side than the gas flow passage is. For example, reference gas such as air is introduced into the reference gas introduction space 43. It is to be noted, however, that the configuration of the gas sensor element 100 need not be limited to such an example. In another example, the first solid electrolyte layer 4 may be configured to extend to the rear end of the gas sensor element 100, and the reference gas introduction space 43 may be omitted. In this case, an air introduction layer 48 may be configured to extend to the rear end of the gas sensor element 100.

The air introduction layer 48 is a layer made of porous alumina and is configured such that reference gas is introduced thereto via the reference gas introduction space 43. In addition, the air introduction layer 48 is formed so as to cover a reference electrode 42.

The reference electrode 42 is formed so as to be held between the upper face of the third substrate layer 3 and the first solid electrolyte layer 4, and is covered by the air introduction layer 48 connected to the reference gas introduction space 43. The reference electrode 42 is used to measure the oxygen concentration (oxygen partial pressure) in the first internal cavity 20 and the second internal cavity 40. This will be described in detail below.

The gas introduction opening 10 is a region that is open to the external space in the gas flow passage. In the present embodiment, as shown in FIGS. 1 and 2, the gas introduction opening 10 is open to the external space on each side face (130, 140). That is, the gas flow passage is configured to have open portions on the respective side faces (130, 140). Each side face (130, 140) in the present embodiment is an example of the first face. On the other hand, on the front face 150, the gas flow passage is closed by a dense ceramic layer 15. The ceramic layer 15 may be made of a material such as zirconia (ZrO₂), for example. The gas sensor element 100 is configured such that measurement target gas is introduced from the external space via the gas introduction opening 10 into the gas sensor element 100.

The first diffusion control unit 11 is a region that applies a predetermined diffusion resistance to the measurement target gas introduced from the gas introduction opening 10.

The buffer space 12 is a space that is provided in order to guide the measurement target gas introduced from the first diffusion control unit 11 to the second diffusion control unit 13.

The second diffusion control unit 13 is a region that applies a predetermined diffusion resistance to the measurement target gas introduced from the buffer space 12 into the first internal cavity 20.

When the measurement target gas is introduced from the outside of the gas sensor element 100 into the first internal cavity 20, the measurement target gas abruptly introduced from the gas introduction opening 10 into the gas sensor element 100 due to a change in the pressure of the measurement target gas in the external space (a pulsation of the exhaust pressure in the case in which the measurement target gas is exhaust gas of an automobile) is not directly introduced into the first internal cavity 20, but is introduced into the first internal cavity 20 after passing through the first diffusion control unit 11, the buffer space 12, and the second diffusion control unit 13 where a change in the concentration of the measurement target gas is canceled. Accordingly, a change in the concentration of the measurement target gas introduced into the first internal cavity is reduced to be almost negligible.

The first internal cavity 20 is provided as a space for adjusting the oxygen partial pressure in the measurement target gas introduced via the second diffusion control unit 13. The oxygen partial pressure is adjusted through an operation of a main pump cell 21.

The main pump cell 21 is an electro-chemical pump cell constituted by an internal pump electrode 22 having a ceiling electrode portion 22a provided over substantially the entire lower face of the second solid electrolyte layer 6 facing the first internal cavity 20, an external pump electrode 23 provided so as to be exposed to the external space in the region corresponding to the ceiling electrode portion 22a on the upper face of the second solid electrolyte layer 6 (i.e., the upper face 110 of the gas sensor element 100), and the second solid electrolyte layer 6 held between these electrodes.

The internal pump electrode 22 is formed across upper and lower solid electrolyte layers (the second solid electrolyte layer 6 and the first solid electrolyte layer 4) that define the first internal cavity 20, and the spacer layer 5 that forms side walls. Specifically, the ceiling electrode portion 22a is formed on the lower face of the second solid electrolyte layer 6 that forms the ceiling face of the first internal cavity 20, a bottom electrode portion 22b is formed on the upper face of the first solid electrolyte layer 4 that forms the bottom face. Side electrode portions (not shown) that connect the ceiling electrode portion 22a and the bottom electrode portion 22b are formed on side wall faces (inner faces) of the spacer layer 5 that form two side wall portions of the first internal cavity 20. That is to say, the internal pump electrode 22 is arranged in the form of a tunnel at the region in which the side electrode portions are arranged.

The internal pump electrode 22 and the external pump electrode 23 are formed as porous cermet electrodes (for example, cermet electrodes formed using Pt containing 1% of Au and ZrO₂). Note that the internal pump electrode 22 with which the measurement target gas is brought into contact is made of a material that has a lowered capability of reducing a nitrogen oxide (NOₓ) component in the measurement target gas.

The gas sensor element 100 is configured such that the main pump cell 21 can apply a desired pump voltage Vp0 to a point between the gas sensor element 22 and the external pump electrode 23, thereby causing a pump current Ip0 to flow in the positive direction or the negative direction between the internal pump electrode 22 and the external pump electrode 23, so that oxygen in the first oxygen 20 is pumped out to the external space or oxygen in the external space is pumped into the first internal cavity 20. When oxygen in the first internal cavity 20 is pumped out to the external space, the oxygen that has pumped out is discharged from the external pump electrode 23. The external pump electrode 23 according to the present embodiment is an example of the gas exhaust unit. The upper face 110 on which the external pump electrode 23 is arranged is an example of the second face.

Furthermore, in order to detect the oxygen concentration (oxygen partial pressure) in the atmosphere in the first internal cavity 20, the internal pump electrode 22, the second solid electrolyte layer 6, the spacer layer 5, the first solid electrolyte layer 4, the third substrate layer 3, and the reference electrode 42 constitute a main pump-controlling oxygen partial pressure detection sensor cell 80 (i.e., an electro-chemical sensor cell).

The gas sensor element 100 is configured to be capable of specifying the oxygen concentration (oxygen partial pressure) in the first internal cavity 20 by measuring an electromotive force V0 in the main pump-controlling oxygen partial pressure detection sensor cell 80. Furthermore, the pump current Ip0 is controlled by performing feedback control on Vp0 such that the electromotive force V0 is kept constant. Accordingly, the oxygen concentration in the first internal cavity 20 can be kept at a predetermined constant value.

The third diffusion control unit 30 is a region that applies a predetermined diffusion resistance to the measurement target gas whose oxygen concentration (oxygen partial pressure) has been controlled through an operation of the main pump cell 21 in the first internal cavity 20, thereby guiding the measurement target gas to the second internal cavity 40.

The second internal cavity 40 is provided as a space for performing processing regarding measurement of the concentration of nitrogen oxide in the measurement target gas introduced via the third diffusion control unit 30. The NOₓ concentration is measured mainly in the second internal cavity 40 whose oxygen concentration has been adjusted by an auxiliary pump cell 50, through an operation of a measurement pump cell 41.

In the second internal cavity 40, the gas sensor element 100 is configured such that the measurement target gas subjected to adjustment of the oxygen concentration (oxygen partial pressure) in advance in the first internal cavity 20 and then introduced via the third diffusion control unit is further subjected to adjustment of the oxygen partial pressure by the auxiliary pump cell 50. Accordingly, the oxygen concentration in the second internal cavity 40 can be precisely kept at a constant value, and the gas sensor element 100 with this configuration thus can measure the NOₓ concentration with high accuracy.

The auxiliary pump cell 50 is an auxiliary electro-chemical pump cell constituted by an auxiliary pump electrode 51, the external pump electrode 23 (which is not limited to the external pump electrode 23, and may be any appropriate electrode outside the gas sensor element 100), and the second solid electrolyte layer 6. The auxiliary pump electrode 51 has a ceiling electrode portion 51a provided on substantially the entire lower face of the second solid electrolyte layer 6 facing the second internal cavity 40.

The auxiliary pump electrode 51 with this configuration is arranged inside the second internal cavity 40 in the form of a tunnel as with the above-described internal pump electrode 22 provided inside the first internal cavity 20. That is to say, the ceiling electrode portion 51a is formed on the second solid electrolyte layer 6 that forms the ceiling face of the second internal cavity 40, and a bottom electrode portion 51b is formed on the first solid electrolyte layer 4 that forms the bottom face of the second internal cavity 40. Side electrode portions (not shown) that connect the ceiling electrode portion 51a and the bottom electrode portion 51b are formed on two wall faces of the spacer layer 5 that form side walls of the second internal cavity 40. Thus, the auxiliary pump electrode 51 is in the form of a tunnel.

Note that the auxiliary pump electrode 51 is also made of a material that has a lowered capability of reducing a nitrogen oxide component in the measurement target gas, as with the internal pump electrode 22.

The gas sensor element 100 is configured such that the auxiliary pump cell 50 can apply a desired voltage Vp1 to a point between the auxiliary pump electrode 51 and the external pump electrode 23, so that oxygen in the atmosphere in the second internal cavity 40 is pumped out to the external space or oxygen in the external space is pumped into the second internal cavity 40.

Furthermore, in order to control the oxygen partial pressure in the atmosphere in the second internal cavity 40, the auxiliary pump electrode 51, the reference electrode 42, the second solid electrolyte layer 6, the spacer layer 5, the first solid electrolyte layer 4, and the third substrate layer 3 constitute an auxiliary pump-controlling oxygen partial pressure detection sensor cell 81 (i.e., an electro-chemical sensor cell).

Note that the auxiliary pump cell 50 performs pumping using a variable power source 52 whose voltage is controlled based on an electromotive force V1 detected by the auxiliary pump-controlling oxygen partial pressure detection sensor cell 81. Accordingly, the oxygen partial pressure in the atmosphere in the second internal cavity 40 is controlled to be a partial pressure that is low enough to not substantially affect the NOₓ measurement.

Furthermore, a pump current Ip1 is used to control the electromotive force of the main pump-controlling oxygen partial pressure detection sensor cell 80. Specifically, the pump current Ip1 is input as a control signal to the main pump-controlling oxygen partial pressure detection sensor cell 80, and the electromotive force V0 is controlled such that a gradient of the oxygen partial pressure in the measurement target gas that is introduced from the third diffusion control unit 30 into the second internal cavity 40 is always kept constant. When the sensor is used as an NOₓ sensor, the oxygen concentration in the second internal cavity 40 is kept at a constant value that is about 0.001 ppm through an operation of the main pump cell 21 and the auxiliary pump cell 50.

The measurement pump cell 41 measures the nitrogen oxide concentration in the measurement target gas, in the second internal cavity 40. The measurement pump cell 41 is an electro-chemical pump cell constituted by a measurement electrode 44, the external pump electrode 23, the second solid electrolyte layer 6, the spacer layer 5, and the first solid electrolyte layer 4. The measurement electrode 44 is provided at a position spaced apart from the third diffusion control unit 30, on the upper face of the first solid electrolyte layer 4 facing the second internal cavity 40.

The measurement electrode 44 is a porous cermet electrode. The measurement electrode 44 functions also as an NOₓ reduction catalyst for reducing NOₓ that is present in the atmosphere in the second internal cavity 40. Furthermore, the measurement electrode 44 is covered by a fourth diffusion control unit 45.

The fourth diffusion control unit 45 is a membrane constituted by a porous member mainly made of alumina (Al₂O₃). The fourth diffusion control unit 45 serves to limit the amount of NOₓ flowing into the measurement electrode 44 and also acts as a protective membrane of the measurement electrode 44.

The gas sensor element 100 is configured such that the measurement pump cell 41 can pump out oxygen generated through degradation of nitrogen oxide in the atmosphere around the measurement electrode 44 and can detect the amount of the generated oxygen as a pump current Ip2.

Furthermore, in order to detect the oxygen partial pressure around the measurement electrode 44, the second solid electrolyte layer 6, the spacer layer 5, the first solid electrolyte layer 4, the third substrate layer 3, the measurement electrode 44, and the reference electrode 42 constitute a measurement pump-controlling oxygen partial pressure detection sensor cell 82 (i.e., an electro-chemical sensor cell). A variable power source 46 is controlled based on a voltage (an electromotive force) V2 detected by the measurement pump-controlling oxygen partial pressure detection sensor cell 82.

The measurement target gas guided into the second internal cavity 40 passes through the fourth diffusion control unit 45 and reaches the measurement electrode 44 with the oxygen partial pressure being controlled. Nitrogen oxide in the measurement target gas around the measurement electrode 44 is reduced to generate oxygen (2NO→N₂+O₂). The generated oxygen is pumped by the measurement pump cell 41, and, at that time, a voltage Vp2 of the variable power source is controlled such that the control voltage V2 detected by the measurement pump-controlling oxygen partial pressure detection sensor cell 82 is kept constant. The amount of oxygen generated around the measurement electrode 44 is proportional to the concentration of nitrogen oxide in the measurement target gas. Thus, it is possible to calculate the concentration of nitrogen oxide in the measurement target gas, using the pump current Ip2 in the measurement pump cell 41.

Furthermore, if the measurement electrode 44, the first solid electrolyte layer 4, the third substrate layer 3, and the reference electrode 42 are combined to constitute an oxygen partial pressure detection means as an electro-chemical sensor cell, it becomes possible to detect an electromotive force that corresponds to a difference between the amount of oxygen generated through reduction of an NOₓ component in the atmosphere around the measurement electrode 44 and the amount of oxygen contained in reference air. This enables the measurement of the concentration of the nitrogen oxide component in the measurement target gas.

Furthermore, the second solid electrolyte layer 6, the spacer layer 5, the first solid electrolyte layer 4, the third substrate layer 3, the external pump electrode 23, and the reference electrode 42 constitute an electro-chemical sensor cell 83. The gas sensor element 100 is configured to be capable of detecting the oxygen partial pressure in the measurement target gas outside the sensor, based on an electromotive force Vref obtained by the sensor cell 83.

In the gas sensor element 100 with the above-described configuration, when the main pump cell 21 and the auxiliary pump cell 50 operate, the measurement target gas whose oxygen partial pressure is always kept at a constant low value (a value that does not substantially affect the NOₓ measurement) can be supplied to the measurement pump cell 41. Accordingly, the gas sensor element 100 is configured to be capable of specifying the nitrogen oxide concentration in the measurement target gas, based on the pump current Ip2 that flows when oxygen generated through reduction of NOₓ is pumped out by the measurement pump cell 41, substantially in proportion to the nitrogen oxide concentration in the measurement target gas.

Furthermore, in order to improve the oxygen ion conductivity of the solid electrolyte, the sensor element 100 includes a heater 70 that serves to adjust the temperature of the sensor element 100 through heating and heat retention. In the example shown in FIG. 3, the heater 70 includes a heater electrode 71, a heat generation unit 72, a lead portion 73, a heater insulating layer 74, and a pressure dispersing hole 75. The lead portion 73 may be provided in the form of a through hole.

In the present embodiment, the heater 70 is arranged on the side closer to the lower face 120 facing the upper face 110 in the gas sensor element 100. That is, the heater 70 is arranged at a position that is closer to the lower face 120 of the gas sensor element 100 than it is to the upper face 110 of the gas sensor element 100 in the thickness direction (vertical direction/stacking direction) of the gas sensor element 100. The lower face 120 is an example of the third face.

The heater electrode 71 is an electrode formed so as to be in contact with the lower face of the first substrate layer 1 (the lower surface 120 of the gas sensor element 100). When the heater electrode 71 is connected to an external power source, electricity can be supplied from the outside to the heater 70.

The heat generation unit 72 is an electrical resistor formed so as to be held between the second substrate layer 2 and the third substrate layer 3 from above and below. The heat generation unit 72 is connected via the lead portion 73 to the heater electrode 71, and, when electricity is supplied from the outside via the heater electrode 71, the heat generation unit 72 generates heat, thereby heating and keeping the temperature of a solid electrolyte constituting the gas sensor element 100.

Furthermore, the heat generation unit 72 is embedded over the entire region from the first internal cavity 20 to the second internal cavity 40, and thus the entire gas sensor element 100 can be adjusted to a temperature at which the above-described solid electrolyte is activated.

The heater insulating layer 74 is an insulating layer constituted by an insulating member made of alumina or the like on upper and lower faces of the heat generation unit 72. The heater insulating layer 74 is formed in order to realize the electrical insulation between the second substrate layer 2 and the heat generation unit 72 and the electrical insulation between the third substrate layer 3 and the heat generation unit 72.

The pressure dispersing hole 75 is a hole that extends through the third substrate layer 3 and is connected to the reference gas introduction space 43, and is formed in order to alleviate an increase in the internal pressure in accordance with an increase in the temperature in the heater insulating layer 74.

Protective Member

As shown in FIGS. 1 and 2, the protective member 200 is configured to at least partially cover the gas sensor element 100. In the example shown in FIGS. 1 and 2, the protective member 200 is configured to cover a portion on the front end side of the gas sensor element 100. Specifically, the protective member 200 covers the entire front face 150 and portions on the front end side of the four faces (110, 120, 130, 140) of the gas sensor element 100. It is to be noted, however, that the extent of coverage by the protective member 200 need not be limited to such an example. As long as the gas introduction opening 10 and the gas exhaust unit (the external pump electrode 23) of the gas sensor element 100 are covered by the protective member 200, the extent to which the gas sensor element 100 is covered by the protective member 200 need not be limited and may be determined as appropriate according to the specifics of implementation. In another example, the protective member 200 may be configured to cover the entire gas sensor element 100.

The protective member 200 includes a plurality of porous layers. The porous layers may each be made of a material such as alumina, for example. The protective member 200 can be formed by thermal-spraying the material onto the gas sensor element 100 in a suitable manner. In another example, the protective member 200 may be formed through slurry coating. In the present embodiment, the plurality of porous layers include first porous layers 211 to 215 arranged on the innermost side and a second porous layer 220 arranged on the outer side of the first porous layers 211 to 215. The state of being “arranged on the innermost side” refers to a state of being arranged on the side closer to the space for accommodating the gas sensor element 100. The state of being “arranged on the outer side of the first porous layers” refers to the state of being arranged on the side closer to the external space than the first porous layers are.

In the example shown in FIGS. 1 and 2, the plurality of porous layers are constituted by two kinds of layers, namely, the first porous layers 211 to 215 and the second porous layer 220. That is, the protective member 200 includes no porous layers other than the first porous layers 211 to 215 and the second porous layer 220. However, the configuration of the plurality of porous layers need not be limited to such as example. In another example, there may be one or more porous layers other than the first porous layers 211 to 215 and the second porous layer 220. The above-described one or more other porous layers may be arranged at least either one of between the first porous layers 211 to 215 and the second porous layer 220 and the outer side of the second porous layer 220. When the protective member 200 includes three or more kinds of porous layers, portions of the protective member 200 covering the open portions of the gas introduction opening 10 may be constituted by two porous layers, namely, the first porous layer (213, 214) and the second porous layer 220. By limiting the number of porous layers present in the portions covering the open portions of the gas introduction opening 10 to two, the responsiveness of the gas sensor S can be ensured while improving the water intrusion resistance of the gas introduction opening 10.

The first porous layers 211 to 215 have a higher porosity than the second porous layer 220. In one example, the porosity of the first porous layers 211 to 215 may be 30% to 70%, whereas the porosity of the second porous layer 220 may be 10% to 40%. The difference between the porosity of the first porous layers 211 to 215 and the porosity of the second porous layer 220 may be 20% to 50%. The porosity need not be the same between the first porous layers 211 to 215. The dimensions of the first porous layer 211 to 215 and the second porous layer 220 may be determined as appropriate according to the specifics of implementation. In one example, the thicknesses of the first porous layers 211 to 215 may be 700 μm or less and preferably 50 μm to 500 μm. The thickness of the second porous layer 220 may be 700 μm or less and preferably 200 μm to 500 μm.

The gas introduction opening 10 of the gas sensor element 100 and the external pump electrode 23 are covered by the protective member 200 so as to be in contact with the first porous layers (211, 213, 214). In the example shown in FIGS. 1 and 2, the first porous layer 211 is configured to cover the external pump electrode 23 and a portion on the front end side of the upper face 110 of the gas sensor element 100. The first porous layer 212 is configured to cover to a portion on the front end side of the lower face 120 of the gas sensor element 100. The first porous layers (213, 214) are configured to cover the open portions of the gas introduction opening 10 and portions on the front end side of the side faces (130, 140) of the gas sensor element 100, respectively. The first porous layer 215 is configured to cover the front face 150 of the gas sensor element 100 and to be continuous with the two first porous layers (213, 214).

The protective member 200 is configured to include restricting portions 231 to 233 between the gas introduction opening 10 and the external pump electrode 23. The restricting portions 231 to 233 are each configured such that the thickness of the first porous layer present therein is reduced as compared with the thicknesses of the portions (the first porous layers (211, 213, 214)) covering the open portions of the gas introduction opening 10 and the external pump electrode 23 to the extent that flow of gas is inhibited, whereby the second porous layer 220 restricts the flow of gas between the gas introduction opening 10 and the external pump electrode 23. To restrict the flow of gas means to reduce the flow of gas, and preferably means to block the flow of gas to a certain extent.

In the present embodiment, the restricting portions 231 to 233 may each be configured such that the first porous layer is not present therein, whereby the second porous layer 220 restricts the flow of gas between the gas introduction opening 10 and the external pump electrode 23. The absence of the first porous layer is achieved by the configuration in which, of all gas passages assumed to be present between the gas introduction opening 10 and the external pump electrode 23 in the protective member 200, the first porous layer is disconnected in at least part of each assumed passage, in other words, continuous passages cannot be formed between the gas introduction opening 10 and the external pump electrode 23 in the protective member 200.

The restricting portions 231 to 233 may be arranged at any positions on the assumed passages between the gas introduction opening 10 and the external pump electrode 23 in the protective member 200. For example, in the present embodiment, the respective side faces (130, 140) have the open portions of the gas introduction opening 10, and the external pump electrode 23 is arranged on the upper face 110. Corners (191, 192) between the respective side faces (130, 140) and the upper face 110 are chamfered. The restricting portions (231, 232) are provided in the chamfered corners (191, 192). The first porous layer 215 covering the front face 150 is continuous with the first porous layers (213, 214) covering the respective side faces (130, 140), and the corner 193 between the upper face 110 and the front face 150 is also chamfered. The restricting portion 233 is provided in the chamfered corner 193. The dimensions of the respective portions can be determined as appropriate according to the specifics of implementation. In one example, the dimension of the chamfered portions may be 50 μm to 300 μm.

In the present embodiment, the heater 70 is arranged on the side closer to the lower face 120 in the gas sensor element 100, and a portion on the front end side of the lower face 120 is covered by the first porous layer 212. The thickness of the first porous layer 212 at a portion covering the lower face 120 may be smaller than the thickness of the first porous layer 211 at a portion covering the external pump electrode 23. When the lower face 120 is also at least partially covered by the first porous layer 212, the gas sensor S can have an increased strength. Further, when the thickness of the first porous layer 211 is greater than the first porous layer 212, the protective member 200 can be adapted such that the strength thereof on the external pump electrode 23 side is enhanced as compared with the strength on the heater 70 side. This can reduce the possibility that cracking may occur in the vicinity of the external pump electrode 23. It is to be noted, however, that the thicknesses of the first porous layers 211 to 215 need not be limited to such an example and may be determined as appropriate according to the specifics of implementation. The thickness of the second porous layer 220 also may be determined as appropriate according to the specifics of implementation. However, the dimensions of the respective constituent elements of the protective member 200 may be determined as appropriate according to the specifics of implementation (for example, the shape, dimensions, and the like of the gas sensor element 100).

In the present embodiment, the second porous layer 220 is configured to cover the first porous layers 211 to 215. The outer shape of the second porous layer 220 (the protective member 200) is formed in a cuboid shape. The cross-sectional shapes of the first porous layers (211, 213, 214) at portions where they cover the open portions of the gas introduction opening 10 and the external pump electrode 23, respectively, are each formed in an arch shape. The “cross-sectional shapes” refer to the shapes of cross-sections perpendicular to the faces provided with the open portions of the gas introduction opening 10 and the external pump electrode 23 (the gas exhaust unit), respectively. In the present embodiment, FIG. 1 shows an example of the cross-sectional shapes of the first porous layers (211, 213, 214). The cross-sectional shapes of the first porous layers (212, 215) are also formed in an arch shape. The arch shape is a shape that is thickest in the middle and gradually becomes thinner toward the both ends. In the example shown in FIGS. 1 and 2, the first porous layers 211 to 215 are each formed in a perfect arc shape. However, the arch shape need not be limited to such a perfect arc shape as long as it is a shape that is thickest near the middle and thinner in the vicinity of the both ends. The protective member 200 with the arch-shaped first porous layers 211 to 215 can exhibit an increased strength. It is to be noted, however, that the shapes of the protective member 200, the first porous layers 211 to 215, and the second porous layer 220 need not be limited to such examples and may be determined as appropriate according to the specifics of implementation.

Characteristics

As described above, in the gas sensor S according to the present embodiment, the gas introduction opening 10 of the gas sensor element 100 and the external pump electrode 23 (the gas exhaust unit) are covered by the protective member 200 in such a manner that they are in contact with the first porous layers (211, 213, 214). In addition, in the protective member 200, the restricting portions 231 to 233 configured to inhibit the flow of gas are provided between the gas introduction opening 10 and the external pump electrode 23. These restricting portions 231 to 233 can keep gas discharged from the external pump electrode 23 from entering the gas introduction opening 10. With this configuration, gas discharged from the external pump electrode 23 can be kept from mixing with a gas to be measured, whereby the measurement accuracy of the gas sensor S can be improved.

In the conventional sensor proposed in JP 2015-059758A, at first, a front end portion of the gas sensor element is entirely covered by the first protective layer, and thereafter, the first protective layer is entirely covered by the second protective layer. This may cause a problem in that the strength may be lowered as the proportion of the first protective layer increases. However, setting the porosity of the first protective layer to a value close to the porosity of the second protective layer may give rise to a problem in that it becomes difficult for gas to enter a gas introduction opening, resulting in deteriorated responsiveness to the gas. Accordingly, it is difficult for the conventional sensor to achieve the durability of the cover without compromising the responsiveness to gas. In contrast, according to the gas sensor S of the present embodiment, the first porous layers have a reduced thickness (in the above embodiment, the first porous layers are not present) in the restricting portions 231 to 233, whereby the amount of the first porous layers in the entire protective member 200 can be reduced. As a result, between the first porous layers 211 to 215 and the second porous layer 220, the area of regions subjected to the change in porosity can be reduced. Therefore, according to the present embodiment, by increasing the porosity of the first porous layers 211 to 215, especially the porosity of the first porous layers (213, 214) covering the gas introduction opening 10, it is expected that the strength of the protective member 200 as a whole can be improved while ensuring the responsiveness to gas.

In the present embodiment, the first porous layers (211, 213, 214, 215) are each formed in an arch shape. The restricting portions 231 to 233 are provided as regions where the first porous layers are not present. The open portions of the gas introduction opening 10 and the external pump electrode 23 are arranged on different faces. Corners (191, 192) between the faces on which they are arranged are chamfered, and the restricting portions (231, 232) are provided in the chamfered corners (191, 192). As a result, the restricting portions 231 to 233 can be provided effectively, thereby allowing effective restriction of the flow of gas between the gas introduction opening 10 and the external pump electrode 23. Accordingly, the measurement accuracy of the gas sensor S can be further improved.

### MODIFIED EXAMPLES

Although the embodiment of the present invention has been described above, the foregoing description on the embodiment is to be construed in all respects as illustrative of the present invention. Various improvements and variations may be made to the above embodiment. Omission, substitution, and/or addition of each constituent element in the above embodiment may be made as appropriate. Moreover, the shape and the dimensions of each constituent element in the above embodiment may be changed as appropriate according to the specifics of implementation. For example, the following changes can be made. In the following, the same constituent elements as those in the above embodiment are given the same reference numerals, and the same descriptions as those in the above embodiment are omitted as appropriate. Modified examples to be described can be combined as appropriate.

(I) Configuration of Restricting Portions

In the above embodiment, the restricting portions 231 to 233 are each configured such that the first porous layer is not present therein, whereby the second porous layer restricts the flow of gas. However, the configuration of the restricting portions need not be limited to such an example. In another example, restricting portions may each be configured such that the average thickness of a first porous layer in the restriction portion is less than 30% of a maximum thickness of the first porous layers in portions where they cover the open portions of the gas introduction opening and the gas exhaust unit, whereby the second porous layer restricts the flow of gas between the gas introduction opening and the gas exhaust unit.

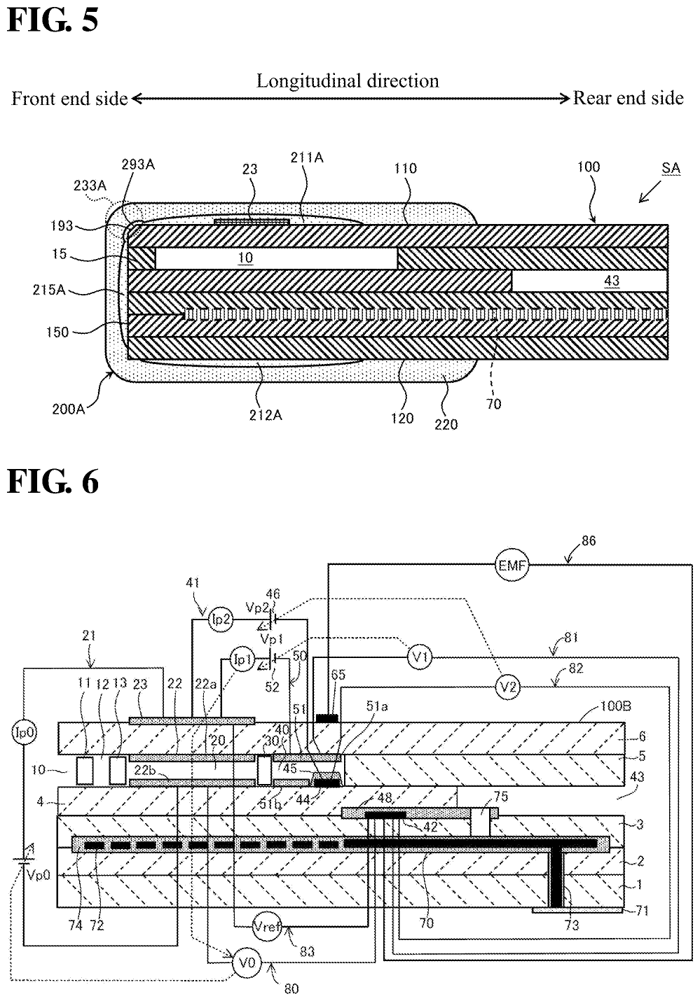

FIG. 4 is a schematic view showing, in order to schematically illustrate an example configuration of a gas sensor SA according to the present modified example, a cross-section of the gas sensor SA perpendicular to the longitudinal direction. FIG. 5 is a schematic view showing, in order to schematically illustrate the example configuration of the gas sensor SA according to the present modified example, a cross-section of the gas sensor SA parallel to the longitudinal direction. FIG. 4 schematically shows the cross-section corresponding to the one shown in FIG. 1, and FIG. 5 schematically shows the cross-section corresponding to the one shown in FIG. 2.

In the present modified example, a protective member 200A includes first porous layers 211A to 215A and a second porous layer 220. The first porous layers 211A to 215A correspond to the first porous layers 211 to 215 in the above embodiment. In the present modified example, the first porous layers 211A to 215A are formed continuously. Restricting portions 231A to 233A correspond to the restricting portions 231 to 233 in the above embodiment, respectively, and are provided in chamfered corners 191 to 193, respectively. Each of the first porous layers 291A to 293A in the respective restricting portions 231A to 233A has an average thickness that is less than 30% of a maximum thickness of the first porous layers (211A, 213A, 214A) in portions where they cover the open portions of the gas introduction opening 10 and the external pump electrode 23 (the gas exhaust unit). Preferably, the average thickness of each of the first porous layers 291A to 293A is less than 20% of the maximum thickness of the first porous layers (211A, 213A, 214A). With this configuration, in each of the restricting portions 231A to 233A, the second porous layer 220 restricts the flow of gas. Except for the above, the gas sensor SA may have the same configuration as the gas sensor S according to the above embodiment.

Maximum thicknesses of the first porous layers (211A, 213A, 214A) may be measured as appropriate in regions near the open portions of the gas introduction opening 10 and a region near the external pump electrode 23 (gas exhaust unit), respectively. In one example, the positions of the maximum thickness are preferably directly above the open portions of the gas introduction opening 10 and the external pump electrode 23 (the gas exhaust unit), respectively. The maximum thickness is preferably 700 μm or less and more preferably 50 μm to 500 μm. Further, in one example, the average thickness of each of the restricting portions 231A to 233A is preferably 15 μm and 200 μm.

According to the present modified example, the average thicknesses of the first porous layers 291A to 293A in the respective restricting portions 231A to 233A are reduced based on the above indication, whereby the restricting portions 231A to 233A effective in restricting the flow of gas can be provided, as in the above embodiment. As a result, the flow of gas between the gas introduction opening 10 and the external pump electrode 23 can be blocked effectively. The present modified example thus enables the improvement of the measurement accuracy of the gas sensor SA.

(II) The Number of Gas Exhaust Units

In the above embodiment, the gas sensor element 100 includes one gas exhaust unit (one external pump electrode 23). However, the number of gas exhaust units provided in the gas sensor element need not be limited to one, and may be two or more. In other words, the gas sensor element may further include one or more other gas exhaust units. In this case, the gas sensor element may include a portion(s) not covered by the protective member, and the other gas exhaust unit(s) may be arranged in the portion(s) not covered by the protective member.

(III) Gas Detection Unit

In the above embodiment, the gas sensor element 100 includes the measurement electrode 44 as a gas detection unit. However, the gas detection unit need not be limited thereto. The number of gas detection units, and the configuration and the arrangement of each gas detection unit can be determined as appropriate according to the specifics of implementation. In another example, the gas sensor element may include a portion(s) not covered by the protective member, and the gas sensor element may further include a gas detection unit(s) arranged in the portion(s) not covered by the protective member.

FIG. 6 is a schematic cross-sectional view schematically illustrating an example configuration of a gas sensor element 100B according to the present modified example. FIG. 6 schematically shows the cross-section corresponding to the one shown in FIG. 3. The gas sensor element 100B includes, on an upper face of a second solid electrolyte layer 6 (an upper face 110 of the gas sensor element 100B), a sensing electrode 65 used for sensing NH₃. In one example, the sensing electrode 65 may be formed as a porous cermet electrode composed of Pt containing Au at a predetermined ratio (in other words, a Pt—Au alloy) and zirconia. In the gas sensor element 100B, the sensing electrode 65, a reference electrode 42, and a solid electrolyte layer present between these electrodes (65, 42) constitute a mixed potential cell 86. With this configuration, the gas sensor element 100B measures the concentration of NH₃ in a measurement target gas by, based on the principle of mixed potential, utilizing the potential difference caused by the difference in NH₃ concentration between regions near the above two electrodes (65, 42). The portion constituting this mixed potential cell 86 may be referred to as a “NH₃ gas sensor portion”.

By defining a suitable composition of the Pt—Au alloy used as a material for forming the sensing electrode 65, the catalytic activity of the sensing electrode 65 against NH₃ gas is inactivated over a predetermined range of NH₃ concentration. That is, by adjusting the composition of the Pt—Au alloy, it is possible to inhibit the degradation reaction of NH₃ gas in the sensing electrode 65. Thus, in the gas sensor element 100B, the sensing electrode 65 is configured such that, selectively for NH₃ gas in the predetermined concentration range, the potential of the sensing electrode 65 varies in a concentration-dependent manner (i.e., has a correlation with the concentration). In other words, the sensing electrode 65 is configured such that the potential thereto exhibits a high concentration dependence for NH₃ gas in the predetermined concentration range, whereas it exhibits a low concentration dependence on other components in a gas to be measured.

More specifically, in the gas sensor element 100B, the Au presence ratio on the surfaces of the Pt—Au alloy particles constituting the sensing electrode 65 is set to a suitable value such that the potential of the sensing electrode 65 exhibits a marked dependence on the concentration of NH₃ gas over a concentration range of 0 ppm to 500 ppm (at least 0 ppm to 100 ppm).

The Au presence ratio means the area ratio of Au-coated portions to Pt-exposed portions on the surfaces of noble metal particles constituting the sensing electrode 65. The Au presence ratio can be calculated as per the following mathematical expression 1, using the detection values for Au and Pt in an Auger spectrum obtained through Auger electron spectroscopy (AES) analysis of the surfaces of the noble metal particles.

Au presence ratio=Au detection value/Pt detection value (Math. 1)

When the area of the Pt-exposed portions is equal to the area of the Au-covered portions, the Au presence ratio is 1.

When the sensing electrode 65 has an Au presence ratio of 0.25 or more, the potential of the sensing electrode 65 exhibits a marked dependence on the NH₃ gas concentration over a concentration range of 0 ppm to 500 ppm. In particular, when the Au presence ratio of the sensing electrode 65 is 0.40 or more, the potential of the sensing electrode 65 exhibits a marked dependence on the NH₃ gas over a concentration range of at least 0 ppm to 100 ppm. The upper limit of the Au presence ratio need not be limited to a particular value. In extreme cases, the surfaces of the noble metal particles constituting the sensing electrode 65 may be entirely coated with Au. In another example, the sensing electrode 65 may be made of Au alone. When the sensing electrode 65 made of a Pt—Au alloy is formed by screen printing and subsequent integrated firing (co-firing) of a solid electrolyte layer and the electrode, the Au presence ratio is preferably set to 2.30 or less. The reason for this is that, since Au has a melting point (1064° C.) lower than the firing temperature, an excessively large Au presence ratio may cause the sensing electrode 65 to melt. The same applies to the case where the sensing electrode 65 is made of Au alone.

Based on a method utilizing a relative sensitivity factor, the Au presence ratio can also be calculated from the peak intensities of the peaks of Au and Pt detected through X-ray photoelectron spectroscopy (XPS) analysis of the surfaces of the noble metal particles. The value of the Au presence ratio calculated by this method and the value of the Au presence ratio calculated based on the result of AES analysis can be regarded as substantially the same.

For electrodes other than the sensing electrode 65, the Au presence ratio may also be calculated using the mathematical expression 1. In one example, it is preferable that an internal pump electrode 22 and an auxiliary pump electrode 51 be provided so as to have an Au presence ratio between 0.01 and 0.3 inclusive. This allows the internal pump electrode 22 and the auxiliary pump electrode 51 to have reduced catalytic activity against components other than oxygen, whereby their capability of selectively degrading oxygen can be enhanced. The Au presence ratio in each of the inner pump electrode 22 and the auxiliary pump electrode 51 is more preferably between 0.1 to 0.25 inclusive and still more preferably between 0.2 and 0.25 inclusive.

On the other hand, a reference electrode 42 is covered by an air introduction layer 48 that is in communication with a reference gas introduction space 43. Thus, when the gas sensor element 100B is in use, the surrounding of the reference electrode 42 is constantly filled with air (oxygen). Accordingly, when the gas sensor element 100B is in use, the potential of the reference electrode 42 always remains constant.

Accordingly, in the mixed potential cell 86 during use of the gas sensor element 100B, for NH₃ gas in a concentration range of at least 0 ppm to 500 ppm, a potential difference EMF is generated between the sensing electrode 65 and the reference electrode 42 in a manner dependent on the NH₃ gas concentration in measurement target gas. Accordingly, the concentration of NH₃ gas in the measurement target gas can be determined based on the potential difference EMF. The sensing electrode 65 is an example of the above-described gas detection unit.

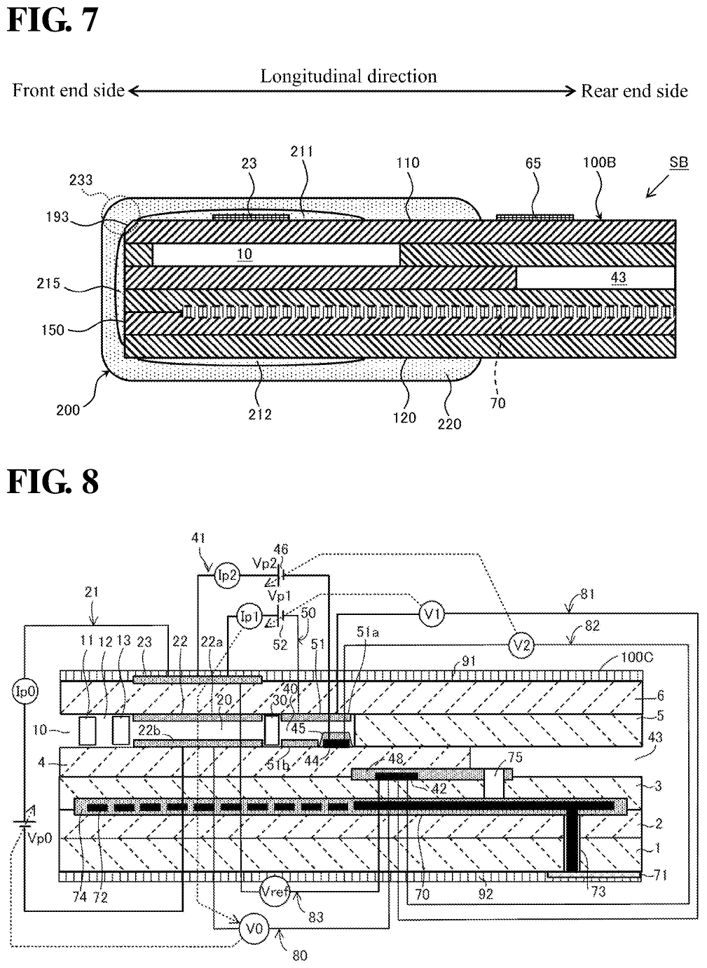

FIG. 7 is a schematic view showing, in order to schematically illustrate an example configuration of a gas sensor SB according to the present modified example, a cross-section of the gas sensor SB parallel to the longitudinal direction. FIG. 7 schematically shows the cross-section corresponding to the one shown in FIG. 2. In gas sensor SB, a protective member 200 covers a portion on the front end side of an upper face 110. A sensing electrode 65 is arranged on the upper face 110 of a gas sensor element 100B, as with an external pump electrode 23. On this upper face 110, the external pump electrode 23 is arranged in a portion covered by the protective member 200 (a first porous layer 211), whereas the sensing electrode 65 is arranged in a portion not covered by the protective member 200. Except for the above, the gas sensor SB and the gas sensor element 100B according to the present modified example may have the same configurations as the gas sensor S and the gas sensor element 100 according to the above embodiment.

According to the present modified example, since the sensing electrode 65 is arranged in the portion not covered by the protective member 200, gas discharged from the external pump electrode 23 can be effectively blocked from reaching the sensing electrode 65. Thus, the gas discharged from the external pump electrode 23 can be kept from mixing with gas to be measured by the sensing electrode 65, thereby enabling the improvement of the measurement accuracy of the gas sensor SB. The types of the gas exhaust unit and the gas detection unit need not be limited to the above-described external pump electrode 23 and sensing electrode 65. The type of gas discharged from the gas exhaust unit and the type of gas detected by the gas detection unit may be selected as appropriate according to the specifics of implementation, such as the configuration of the gas sensor element and a component to be measured.

(IV) Configuration of Gas Sensor Element

Omission, substitution, and/or addition of each constituent element of the gas sensor element 100 in the above embodiment may be made as appropriate. When the gas sensor element is constituted by stacking solid electrolyte layers, it is only necessary that the gas sensor element include a plurality of solid electrolyte layers and the number of solid electrolyte layers to be stacked may be changed as appropriate. In this case, of the plurality of solid electrolyte layers, a face of the solid electrolyte layer arranged on at least one of outermost sides in the stacking direction may be at least partially covered by an insulating layer. In addition, the gas sensor element may be configured such that, in a portion covered by the insulating layer, the gas sensor element is covered by the protective member with the insulating layer interposed therebetween.

FIG. 8 is a schematic cross-sectional view schematically illustrating an example configuration of a gas sensor element 100C according to the present modified example. FIG. 8 schematically shows the cross-section corresponding to the one shown in FIG. 3. The gas sensor element 100C according to the present modified example includes six solid electrolyte layers (a first substrate layer 1, a second substrate layer 2, a third substrate layer 3, a first solid electrolyte layer 4, a spacer layer 5, and a second solid electrolyte layer 6), as in the above embodiment. Of these six solid electrolyte layers, the first substrate layer 1 and the second solid electrolyte layer 6 are arranged on the outermost sides in the stacking direction. In the example shown in FIG. 8, the upper face of the second solid electrolyte layer 6 is entirely covered by an insulating layer 91, and the lower face of the first substrate layer 1 is entirely covered by an insulating layer 92. Each insulating layer (91, 92) may be made of a material such as alumina, for example. Except for the above, the gas sensor element 100C may have the same configuration as the gas sensor element 100 according to the above embodiment.

In the portion covered by each insulating layer (91, 92), the gas sensor element 100C may be covered by a protective member 200 with each insulating layer (91, 92) interposed therebetween. According to the present modified example, the insulating layers (91, 92) can be made of the same material as the porous layers of the protective member 200. Accordingly, when the gas sensor element 100C, which is constituted by the plurality of solid electrolyte layers, is covered by the porous layers of the protective member 200 with the insulating layers (91, 92) interposed therebetween, the adhesion between the gas sensor element 100C and the protective member 200 can be enhanced as compared with the case where the gas sensor element 100C is directly covered by the porous layers. As a result, it is possible to provide a gas sensor in which detachment of the protective member 200 is less likely to occur.

In the present modified example, either one of the two insulating layers (91, 92) may be omitted. At least one of the lower face of the first substrate layer 1 and the upper face of the second solid electrolyte layer 6 may be partially exposed. In other words, at least one of the lower face of the first substrate layer 1 and the upper face of the second solid electrolyte layer 6 may include a region not covered by the insulating layer (91, 92). The insulating layer 91 may also cover the external pump electrode 23. In this case, the external pump electrode 23 need not be in direct contact with the protective member 200 (the first porous layer 211). The same applies to the above-described sensing electrode 65.

(V) Arrangement of Open Portion(s) of Gas Introduction Opening and Gas Exhaust Unit

In the above embodiment, the respective side faces (130, 140) have the open portions of the gas introduction opening 10, and the external pump electrode 23 (gas exhaust unit) is arranged on the upper face 110. However, the arrangement of the open portions of the gas introduction opening and the gas exhaust unit need not be limited to this example, and may be selected as appropriate according to the specifics of implementation. As another example, in the above embodiment, at least one of the open portion on the first side face 130 and the open portion on the second side face 140 may be omitted. That is to say, either one of the first side face 130 and the second side face 140 may have an open portion of the gas introduction opening 10. In still another example, instead of the first side face 130 and the second side face 140, the front face 150 may have an open portion of the gas introduction opening 10.

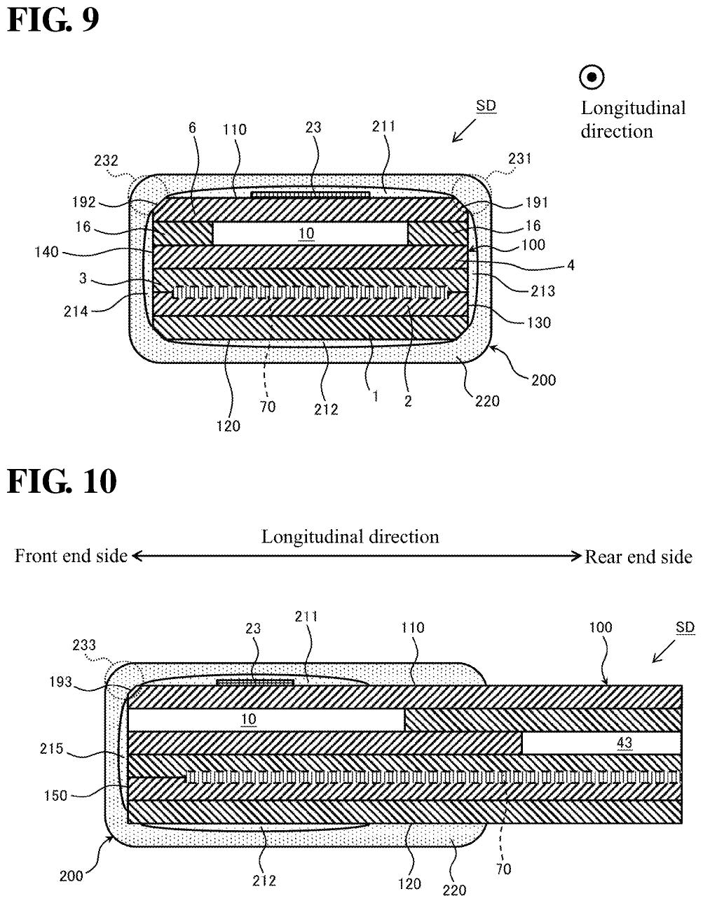

FIG. 9 is a schematic view showing, in order to schematically illustrate an example configuration of a gas sensor SD according to the present modified example, a cross-section of the gas sensor SD perpendicular to the longitudinal direction. FIG. 10 is a schematic view showing, in order to schematically illustrate the example configuration of the gas sensor SD according to the present modified example, a cross-section of the gas sensor SD parallel to the longitudinal direction. FIG. 9 schematically shows the cross-section corresponding to the one shown in FIG. 1, and FIG. 10 schematically shows the cross-section corresponding to the one shown in FIG. 2.

In the gas sensor SD according to the present modified example, a gas flow passage is closed by dense ceramic layers 16 on respective side faces (130, 140). The ceramic layers 16 may have the same configuration as the ceramic layer 15 according to the above embodiment. On the other hand, a gas introduction opening 10 is open to the front face 150 side. In other words, the front face 150 has the gas introduction opening 10. In the preset modified example, the front face 150 is an example of the first face. Except for the above, the gas sensor SD may have the same configuration as the gas sensor S according to the above embodiment. According to the present modified example, it is possible to provide a gas sensor SD intended to improve the measurement accuracy, as with the above embodiment.

### EXAMPLES

In order to verify the effects of the present invention, gas sensors according to the following examples and comparative examples were produced. It is to be noted, however, that the present invention is not limited to the following examples.

As a gas sensor according to Example 1, a gas sensor having the configuration shown in FIGS. 1 and 2 and including a gas sensor element with the configuration shown in FIG. 3 were produced. In Example 1, a protective member was constituted by two kinds of porous layers (first porous layers and a second porous layer). The first porous layers covering a gas introduction opening and a gas exhaust unit each had an arch-shaped cross-section. The respective side faces of the gas sensor element had open portions of the gas introduction opening, the gas exhaust unit was arranged on an upper face of the gas sensor element, and the corner between each side face and the upper face was chamfered. Restricting portions were provided in the chamfered corners between the gas introduction opening and the gas exhaust unit. Each restricting portion was provided as a portion in which the first porous layer was not present.

A gas sensor according to Example 2 was produced by omitting the chamfering for providing restricting portions in the gas sensor of Example 1. A gas sensor according to Example 3 was produced by using, instead of the restricting portions in Example 2, restricting portions in each of which an average thickness of the first porous layer was 3% of a maximum thickness of the first porous layers in portions where they covered the open portions of the gas introduction opening and the gas exhaust unit. A gas sensor according to Example 4 was produced by using, instead of the restricting portions in Example 1, restricting portions in each of which an average thickness of the first porous layer was 18% of a maximum thickness of the first porous layers in portions where they covered the open portions of the gas introduction opening and the gas exhaust unit. A gas sensor according to Example 5 was produced by changing the average thickness of the first porous layer in each restricting portion in Example 3 to 28% of the maximum thickness of the first porous layers in the portions where they covered the gas introduction opening and the gas exhaust unit. In Examples 3 to 5, the maximum thickness of the first porous layers in the portions where they covered the open portions of the gas introduction opening and the gas exhaust unit was 150 μm. A gas sensor according to Example 6 was produced by changing the shape of the cross-sections of the first porous layers in the portions where they covered the gas introduction opening and the gas exhaust unit to a rectangular shape such that the boundary between each first porous layer and the second porous layer was approximately parallel to the gas sensor element.

A gas sensor according to Comparative Example 1 was produced by modifying the configuration used in Example 1 as follows: the first porous layers covering the gas introduction opening were omitted; the cross-sectional shape of the first porous layer covering the gas exhaust unit was changed to the same shape as in Example 6; and the restricting portions were omitted. A gas sensor according to Comparative Example 2 was produced by modifying the configuration used in Example 1 as follows: the first porous layer covering the gas exhaust unit was omitted; the cross-sectional shape of the first porous layers covering the gas introduction opening was changed to the same shape as in Example 6; and the restricting portions were omitted. A gas sensor according to Comparative Example 3 was produced by modifying the configuration used in Example 1 so as to omit the restricting portions. A gas sensor according to Comparative Example 4 was produced by changing the average thickness of the first porous layer in each restricting portion in Example 4 to 32% of the maximum thickness (150 μm) of the first porous layers in the portions where they covered the open portions of the gas introduction opening and the gas exhaust unit. A gas sensor according to Comparative Example 5 was produced by changing the average thickness of the first porous layer in each restricting portion in Example 4 to 63% of the maximum thickness of the first porous layers in the portions where they covered the open portions of the gas introduction opening and the gas exhaust unit.

A gas containing oxygen at a concentration of 5% and a gas containing oxygen at a concentration of 20.5% were supplied to the gas introduction opening of the gas sensor according to each of the examples and comparative examples, and pump currents Ip0 detected for these gases were measured. Thereafter, for the gas sensor according to each of the examples and comparative examples, the linear ratios (%) of the pump currents Ip0 were calculated as per the following mathematical expressions 2 to 4.

Linear ratio (%)=(Slope of line segment AD/Slope of line segment AB)×100 (Math. 2)

Slope of line segment AD=Value of Ip0(20.5%)/20.5 (Math. 3)

Slope of line segment AB=Value of Ip0(5%)/5 (Math. 4)

The value of Ip0 (20.5%) indicates the value of Ip0 for the gas containing oxygen at a concentration of 20.5%, and the value of Ip0 (5%) indicates the value of Ip0 for the gas containing oxygen at a concentration of 5%.

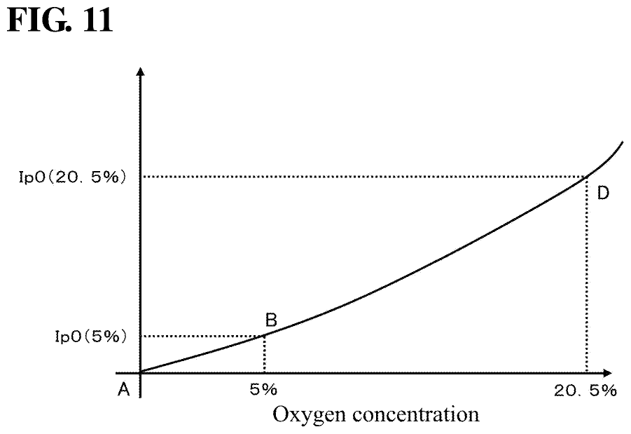

FIG. 11 is a graph illustrating the linear ratio of the above-described Ip0. The line segments AB and AD are as shown in FIG. 11. When the amount of oxygen discharged from the gas exhaust unit and then entering the gas introduction opening increases in proportion to an increase in the oxygen concentration in gas, the slope of Ip0 plotted against the oxygen concentration increases. The higher the extent to which oxygen discharged from the gas exhaust unit is kept from mixing with gas to be measured by restricting the flow of gas between the gas introduction opening and the gas exhaust unit, the more effectively such an increase of the slope can be prevented, whereby the calculated linear ratio (%) approaches 100. That is to say, as the calculated linear ratio (%) becomes closer to 100, it means that calibration can be performed more easily (the oxygen concentration can be measured with similar accuracy in any concentration range) and the measurement accuracy is improved (i.e., it is ideal). Thus, regarding the gas sensor according to each of the examples and comparative examples, the Ip0 linearity was evaluated based on the difference between the calculated linear ratio (%) and the ideal value (100%). The evaluation was made as follows based on the difference from 100%: the Ip0 linearity was evaluated as “A” when the difference was less than 5%, “B” when the difference was 5% or more and less than 30%, and “C” when the difference was 30% or more. Table 1 below shows the results of evaluating the Ip0 linearity. In Table 1, the “1st Layer” refers to the first porous layer, and the “2nd Layer” refers to the second porous layer.

TABLE 1

| | Gas introduction | | | | Restricting portion | | | | |
|---|---|---|---|---|---|---|---|---|---|
| | opening | | Gas exhaust unit | | | Structure of | | Chamfering | |
| | Contact | | Contact | | Presence/ | restricting | Thickness, | Presence/ | Ip0 |
| | layer | Shape | layer | Shape | Absence | portion | % | Absence | linearity |
| Ex. 1 | 1st layer | Arch | 1st layer | Arch | Present | 2nd layer | — | Present | A |
| Ex. 2 | 1st layer | Arch | 1st layer | Arch | Present | 2nd layer | — | Absent | A |
| Ex. 3 | 1st layer | Arch | 1st layer | Arch | Present | 1st layer | 3% | Absent | A |
| Ex. 4 | 1st layer | Arch | 1st layer | Arch | Present | 1st layer | 18% | Present | A |
| Ex. 5 | 1st layer | Arch | 1st layer | Arch | Present | 1st layer | 28% | Absent | B |
| Ex. 6 | 1st layer | — | 1st layer | — | Present | 2nd layer | — | Present | A |
| Comp. Ex. 1 | 2nd layer | — | 1st layer | — | Absent | — | — | Present | C |
| Comp. Ex. 2 | 1st layer | — | 2nd layer | — | Absent | — | — | Present | C |
| Comp. Ex. 3 | 1st layer | Arch | 1st layer | Arch | Absent | — | — | Present | C |
| Comp. Ex. 4 | 1st layer | Arch | 1st layer | Arch | Present | 1st layer | 32% | Present | C |
| Comp. Ex. 5 | 1st layer | Arch | 1st layer | Arch | Present | 1st layer | 63% | Present | C |

As can be seen from the evaluation results in Table 1, the gas sensors according to the examples exhibited more favorable Ip0 linearity than the gas sensors according to the comparative examples. From these results, it was found that the present invention can provide a gas sensor with improved measurement accuracy. Further, the gas sensor of Example 5 could achieve an improved Ip0 linearity as compared with the gas sensor of Comparative Example 4. This result demonstrates that, in the case where restricting portions are provided by reducing the thickness of the first porous layers in the restricting portions, it is possible to effectively provide the restricting portions by setting an average thickness of the first porous layers in the restricting portions to less than 30% of a maximum thickness of the first porous layers in the portions where they cover the open portions of the gas introduction opening and the gas exhaust unit, whereby the flow of gas between the gas introduction opening and the gas exhaust unit can be blocked effectively. Moreover, from the evaluation result regarding the gas sensor of Example 4, it was found that the flow of flow of gas between the gas introduction opening and the gas exhaust unit can be blocked still more effectively by setting an average thickness of the first porous layers in the restricting portions to less than 20% of a maximum thickness of the first porous layers in the portions where they cover the open portions of the gas introduction opening and the gas exhaust unit. These results verified that the above embodiment and modified examples can provide gas sensors with improved measurement accuracy.

### LIST OF REFERENCE NUMERALS

S Sensor
100 Gas sensor element
110 Upper face (second face)
120 Lower face (third face)
130 First side face (first face)
140 Second side face (first face)
150 Front face (first face)
191 to 193 Corner
10 Gas introduction opening
23 External pump electrode (gas exhaust unit)
65 Sensing electrode (another gas exhaust unit)
70 Heater
200 Protective member
211 to 215 First porous layer
220 Second porous layer
231 to 233 Restricting portion

What is claimed is:

1. A gas sensor comprising:
a gas sensor element including a gas introduction opening and a gas exhaust unit; and
a protective member including a plurality of porous layers and configured to cover the gas sensor element,
wherein the plurality of porous layers include a first porous layer arranged on an innermost side and a second porous layer arranged on an outer side of the first porous layer,
the first porous layer has a higher porosity than the second porous layer,
the gas introduction opening and the gas exhaust unit of the gas sensor element are covered by the protective member in such a manner that the gas introduction opening and the gas exhaust unit are in contact with the first porous layer, and
the protective member includes, between the gas introduction opening and the gas exhaust unit, a restricting portion configured such that a thickness of the first porous layer present therein is reduced as compared with thicknesses of portions covering the gas introduction opening and the gas exhaust unit to such an extent that flow of gas is inhibited, whereby the second porous layer restricts the flow of gas between the gas introduction opening and the gas exhaust unit.

2. The gas sensor according to claim 1,
wherein a cross-sectional shape of the first porous layer in each of a portion where the first porous layer covers the gas introduction opening and a portion where the first porous layer covers the gas exhaust unit is in an arch shape.

3. The gas sensor according to claim 1,
wherein the restricting portion is configured such that the first porous layer is not present therein, whereby the second porous layer restricts the flow of gas between the gas introduction opening and the gas exhaust unit.

4. The gas sensor according to claim 1,
wherein, in the restriction portion, an average thickness of the first porous layer is less than 30% of a maximum thickness of the first porous layer in portions where the first porous layer covers the gas introduction opening and the gas exhaust unit, whereby the second porous layer restricts the flow of gas between the gas introduction opening and the gas exhaust unit.

5. The gas sensor according to claim 1,
wherein a portion of the protective member covering the gas introduction opening is constituted by two porous layers consisting of the first porous layer and the second porous layer.

6. The gas sensor according to claim 1,
wherein the gas sensor element includes a first face and a second face that is in contact with the first face,
the gas introduction opening is on the first face,
the gas exhaust unit is arranged on the second face,
a corner between the first face and the second face is chamfered, and
the restricting portion is provided in the chamfered corner.

7. The gas sensor according to claim 6,
wherein the gas sensor element further includes a third face,
the gas sensor element further includes a heater arranged on a side closer to the third face, and
a thickness of the first porous layer in a portion where the first porous layer covers the third face is smaller than a thickness of the first porous layer in a portion where the first porous layer covers the gas exhaust unit.

8. The gas sensor according to claim 1,
wherein the gas sensor element includes a portion not covered by the protective member, and
the gas sensor element further includes a gas detection unit arranged in the portion not covered by the protective member.

9. The gas sensor according to claim 1,
wherein the gas sensor element includes a plurality of solid electrolyte layers being stacked together,
of the plurality of solid electrolyte layers, a face of the solid electrolyte layer arranged on at least one of outermost sides in a stacking direction is at least partially covered by an insulating layer, and
in a portion covered by the insulating layer, the gas sensor element is covered by the protective member with the insulating layer interposed between the gas sensor element and the protective member.
